(19) United States
(12) Patent Application Publication
(10) Pub. No.: US 2007/0037033 A1
(43) Pub. Date: Feb. 15, 2007

(54) Separator for fuel cell, fuel cell stack, method for manufacturing separator for fuel cell, and fuel cell vehicle

(75) Inventors: Nobutaka Chiba, Kanagawa-ken (JP); Keizo Otani, Kanagawa-ken (JP); Shinji Ooe, Kanagawa-ken (JP); Makoto Kano, Kanagawa-ken (JP)

Correspondence Address: FOLEY AND LARDNER LLP;SUITE 500, 3000 K STREET NW, WASHINGTON, DC, 20007, US

(73) Assignee: Nissan Motor Co., Ltd., Kanagawa (JP)

(21) Appl. No.: 10/572,741

(22) PCT Filed: Aug. 19, 2004
(86) PCT No.: PCT/JP04/12231

§ 371 Date: Mar. 21, 2006

(30) Foreign Application Priority Data
Sep. 22, 2003 (JP) 2003-330633
Jun. 1, 2004 (JP) 2004-162988

(51) Int. Cl. H01M 8/04; H01M 8/00; H01M 2/18; H01M 2/14; H01M 8/02

(52) U.S. Cl. 429/34; 429/247; 180/65.1; 72/379.6

(57) ABSTRACT

A separator for a fuel cell comprises a corrugated or undulated gas flow path portion (4) formed on central portion (2) of a clad thin plate: and a flat portion (6) formed on an outer periphery of the central portion, wherein the clad thin plate is obtained by applying rolling work on a metal plate whose surface is covered with a precious metal layer at a draft of 5% to 15% to make clad, and a limit plate thickness residual rate indicating a boundary limit in which cracking of the precious metal layer in the clad thin plate and reduction of corrosion resistance due to exposure of the metal plate are negligible is obtained in advance, wherein regarding a sectional shape in a direction orthogonal to a flow path of the gas flow path portion (4), when a plate thickness of the thinnest portion of a rib shoulder portion is represented as t2 and a plate thickness of a peripheral portion of the separator is represented as t4, a relationship of t2≧t4×limit plate thickness residual rate is satisfied.

### TECHNICAL FIELD

The present invention relates to a separator for a fuel cell, a fuel cell, a manufacturing method thereof, and a fuel cell vehicle.

### BACKGROUND ART

A fuel cell is an apparatus which causes hydrogen gas and oxygen gas which are fuels to electro chemically react with each other to directly convert chemical energy of the fuels to electrical energy. As the fuel cell, there are of a solid polymer electrolytic type, of a phosphoric acid type, of a melt carbonate type, of a solid oxide type and the like according to the type of electrolyte used. A fuel cell of the solid polymer electrolytic type as one among the above types is a battery cell utilizing such a fact that a polymer resin membrane having proton exchanger in a molecule is used as electrolyte and when the polymer resin membrane is hydrated up to a saturated state, it functions as a proton conductive electrolyte. Since the fuel cell of the solid polymer electrolytic type operates at a relatively low temperature and has a high power generating efficiency, it is expected to have various applications including one for mounting on an electric automobile.

The fuel cell of the solid polymer electrolytic type includes a fuel cell stack, and the fuel cell stack is constituted integrally by stacking a plurality of unit cells, each constituted as a basic unit, sandwiching the stacked unit cells at both ends thereof with end flanges and fixing them using fastening bolts. The unit cell constituting the fuel cell stack has a membrane electrode joined body obtained by joining and unifying an oxygen electrode and a hydrogen electrode to both sides of the solid polymer electrolytic membrane. The oxygen electrode and the hydrogen electrode each have a two-layered structure provided with a reaction membrane and a gas diffusion layer, and the reaction membrane is formed on the side of the solid polymer electrolytic membrane. An oxygen electrode side separator and a hydrogen electrode side separator are respectively disposed on both the sides of the oxygen electrode and the hydrogen electrode, and oxygen gas flow paths, hydrogen gas flow paths and cooling water flow paths are defined by the respective separators.

The unit cell with the above constitution is manufactured by arranging an oxygen electrode and a hydrogen electrode on both sides of a solid polymer electrolytic membrane, generally joining them integrally by a hot press method to constitute a membrane electrode joined body, and arranging separators on both sides of the membrane electrode joined body. The oxygen electrode and the hydrogen electrode are each porous, and gas or water passes therethrough. In the fuel cell constituted of the unit cells, when mixed gas of hydrogen, carbon dioxide, nitrogen and steam is supplied to the hydrogen electrode side, and air and steam are supplied to the oxygen electrode side, electro chemical reaction principally occurs on a contacting face of the solid polymer electrolytic membrane and the reaction membrane. A more specific reaction will be explained below.

In the fuel cell stack constituted above, when oxygen gas and hydrogen gas are respectively supplied to the oxygen gas flow path and the hydrogen gas flow path, the oxygen gas and the hydrogen gas are supplied to the reaction membranes side via respective gas diffusion membranes, so that reactions occur on the reaction membranes on the hydrogen electrode side and on the oxygen electrode side.
Hydrogen electrode side: H₂→2H⁺+2e⁻ Formula (1)
Oxygen electrode side: (½)O₂+2H⁺+2e⁻→H₂O Formula (2)

When hydrogen gas is supplied to the hydrogen electrode side, the reaction shown with the formula (1) progresses to generate 2H⁺ and 2e⁻. 2H⁺ moves inside the solid polymer electrolytic membrane in a hydrated state to flow to the oxygen electrode side, and 2e⁻ flows from the hydrogen electrode to the oxygen electrode through a load. On the oxygen electrode side, the reaction shown with the Formula (2) progresses due to 2H⁺, 2e⁻ and supplied oxygen gas to generate power.

Since each separator used in the above fuel cell stack has a function of electrically connecting adjacent unit cells, it is required to have excellent electrical conductivity and have a low contact resistance as constituent material. Since the separator isolates hydrogen gas from oxygen gas, it is required to have a high gas-tight property to reaction gas with hydrogen gas or oxygen gas. Further, since each gas supplied to the fuel cell has a temperature as high as temperature of 80° C. to 90° C. and the separator is exposed to gas with a high temperature, it is required to have corrosion resistance to reaction at oxidization/reduction of hydrogen gas and oxygen gas.

A separator, wherein carbon as raw material is formed in a plate shape and reaction gas flow paths are formed on both surfaces of the plate, is disclosed (refer to “Development and practical use of Solid polymer type fuel cell”, published in 1999, Technical Information Institute Co., Ltd. (Page 92))

In a unit cell using plate-shaped separators made of carbon, a membrane electrode joined body is constituted by disposing an oxygen electrode and a hydrogen electrode on both surfaces of a solid polymer electrolytic membrane and separators are disposed on both surfaces of the membrane electrode joined body.

However, although the separator made of carbon can reduce a contact resistance between the separator and a constituent material such as gas diffusion electrode and a low contact resistance value can be maintained. However, its strength is lower than that of a separator made of metal. There is a demand to reduce thickness of a separator to reduce a fuel cell in size for mounting a fuel cell on a moving vehicle such as an automobile. However, there is a limitation in reduction in thickness of the separator and the separator must have a thickness of at least 1 mm to 5 mm or so.

Japanese Patent Application Laid-open No. 2000-323149 and No. 2002-190305 discloses a separator with a continuous corrugated section wherein a metal thin plate is press-formed, enables to realize downsizing and cost reduction of a fuel cell.

Japanese Patent Application Laid-open No. 2002-260681 and No. 2002-254180 disclose a separator wherein it is obtained by forming a precious metal layer on a surface of a metal plate, performing rolling work at a draft of 5% or more to make a clad alloy thin plate through cladding, performing a press forming on the clad alloy thin plate in a predetermined shape, and forming a gas passage which allows flow of hydrogen gas or oxygen gas. According to this technique, since surface-coating of a precious metal layer is performed on a base material as a coating film and both of the base material and the precious metal layer as the coating film is rolled, a closely adhering force between the both becomes high, so that a closely adhering force approximately equal to that of a clad material can be obtained. A porous structure of the precious metal layer can be made fine and pinholes thereon are closed so that corrosion resistance is improved. Therefore, even if deformation process is performed after rolling, the precious metal layer as the coating film does not peel off. Further, since corrosion resistance is improved by rolling, the coating film is thinned to reduce cost, and since the precious metal layer is formed on the surface, a contacting electric resistance with a constituent material such as a gas diffusion electrode can be lowered.

### DISCLOSURE OF INVENTION

However, in the separator obtained by forming precious metal layers on both surfaces of a metal plate, performing rolling work on the metal plate at a draft of 5% to 15% to make a clad alloy thin plate, using the clad alloy thin plate and performing press-forming to obtain a predetermined shape, in order to obtain a predetermined sectional shape, excessive elongation strain occurs locally on an underlying base member particularly on a rib shoulder portion of a sectional shape on a reaction gas flow path portion worked strongly. Further, the precious metal layer as a surface layer cannot follow this strain, many fine cracks in a range of several micro meters to several tens of micro meters occur in the precious metal layer as the surface layer, and the underlying base member is exposed at the cracked portion thereof. Accordingly, corrosion resistance lowers and improvement of corrosion resistance proportional to formation of the precious metal layer on the surface cannot be obtained.

Further, fine cracks in the surface layer precious metal layer are not caused by defects in the precious metal layer itself but caused by locally excessive elongation strain on the underlying base member, and the fact that the surface layer precious metal layer cannot follow the strain. Thus, there is a risk that the precious metal layer might finely crack.

In order to solve the above problem, when a predetermined separator shape is obtained through a press forming by forming a precious metal layer on a surface of a metal plate and using a clad alloy thin plate obtained by performing rolling work on the metal plate at draft of 5% to 15%, the present inventors eagerly made research about a relationship between a press forming method, and a gas flow path sectional shape of a product and fine cracks occurring in a precious metal layer, for preventing occurrence of fine cracks in a rib shoulder portion of the surface layer precious metal layer and lowering of corrosion resistance due to exposure of the metal plate as the underlying base member due to occurrence of fine cracks. Then, the inventors found such a fact that, for press-forming the clad thin plate to a predetermined shape, when a multi-stage forming including two or more stages of at least one preliminary press forming step for elongating a material and a finishing press forming step for attaining the predetermined shape is performed, fine cracks occur in the precious metal layer due to exposure of the metal plate as the underlying base member at a time of not the preliminary press forming step but the finishing press forming step. Further, the inventors also found that the fine cracks cannot be reproduced by a uniaxial tension test and they cannot be reproduced unless using a spherical head punch stretch forming test which could apply plane strain increasing a surface area. Moreover, in the spherical head punch stretch forming test, the inventors also found that, when a plane strain amount and a plate thickness reduction amount are suppressed to certain values, fine cracks do not occur (a fine crack occurrence limiting plane strain or a fine crack occurrence limiting plate thickness residual rate exists varyingly due to the base member of the clad material, the quality of the surface precious metal layer, and the draft during an operation for making clad). Further, the inventors found that when a thickness reduction ratio of the rib shoulder portion is suppressed to a value obtained by a fine crack reproduction test or less, or ratio of a radius of curvature of the rib shoulder portion to the plate thickness is of a certain value or more, the occurrence of fine cracks could be suppressed to a negligible range with a view to corrosion resistance. In addition, the inventors also found that, in order to obtain a predetermined sectional shape, it is important to increase a formation height at the preliminary press forming step of the multi-stage press forming to a formation height of a product at a ratio of a predetermined value or more, and to preliminarily elongate a material sufficiently during the preliminary press forming such that bending of the rib shoulder portion and compression strain could be simultaneously supported at the finishing press forming step. Further, from these results, the inventors found that occurrence of fine cracks could be suppressed to a negligible range in view of the corrosion resistance and completed this invention based on the above findings.

In one aspect according to the present invention, a separator for a fuel cell comprises a corrugated or undulated gas flow path portion formed on central portion of a clad thin plate: and a flat portion formed on an outer periphery of the central portion, wherein the clad thin portion is obtained by applying rolling work on a metal plate whose surface is covered with a precious metal layer at a draft of 5% to 15% to make clad, a limit plate thickness residual rate (a value obtained by dividing a plate thickness of the clad thin plate after working by an original plate thickness thereof) indicating a boundary limit in which cracking of the precious metal layer in the clad thin plate and reduction of corrosion resistance due to exposure of the metal plate are negligible is obtained in advance, wherein regarding a sectional shape in a direction orthogonal to a flow path of the gas flow path portion, when a plate thickness of a rib central portion contacting with a gas diffusion layer is represented as t1, a plate thickness of the thinnest portion of a rib shoulder portion is represented as t2, a plate thickness of a rib slope portion is represented as t3, and a plate thickness of a peripheral portion of the separator is represented as t4, a relationship of t2≧t4×limit plate thickness residual rate is satisfied.

In another aspect according to the present invention, a fuel cell stack, comprises: a membrane electrode joined body formed on both surfaces of an electrolytic membrane with an oxidizing agent electrode and a fuel electrode, an oxidizing agent electrode side separator disposed on the side of the oxidizing agent electrode of the membrane electrode joined body, and a fuel electrode side separator disposed on the side of the fuel electrode of the membrane electrode joined body, in which a plurality of unit cells formed with an fuel gas flow path and an oxidizing gas flow path between the membrane electrode joined body and the respective separators are stacked, and a cooling water flow path is formed between the respective unit cells, wherein each of the oxidizing agent electrode side separator and the fuel electrode side separator is the separator for a fuel cell according to the above separator a separator for a fuel cell.

Sated another way, in another aspect according the present invention, a fuel cell vehicle which is mounted with the fuel cell stack according to the above a fuel cell stack and uses the fuel cell stack as power source.

In the meanwhile, in another aspect, the present invention provides a method for manufacturing a separator for a fuel cell comprising: preliminary press forming a clad thin plate obtained by forming a precious metal layer on a surface of a metal plate to perform rolling work on the metal plate at a draft of 5% to 15% to make clad to elongate the clad thin plate; and finishing press forming the clad thin plate in a predetermined corrugated shape to form a gas flow path portion.

Other and further features, advantages, and benefits of the present invention will become more apparent from the following description taken in conjunction with the following drawings.

### BRIEF DESCRIPTION OF DRAWINGS

FIG. 1 is a top view of a gas flow path face side of a separator for a solid polymer type fuel cell on which an interdigitated type flow path is formed in a first embodiment of the present invention.

FIG. 2 is a schematic view of a sectional shape of the separator for a solid polymer type fuel cell shown in FIG. 1.

FIG. 3 is a schematic perspective view of a gas flow path portion of the separator for a solid polymer type fuel cell shown in FIG. 1.

FIG. 4 is an optical microscopic photograph showing a sectional shape on a gas flow path portion of a separator of Example 1.

FIG. 5 is an optical microscopic photograph showing a sectional shape on a gas flow path portion of a separator of Comparative Example 2.

FIG. 6 is an optical microscopic photograph showing a sectional shape of a separator after completion of preliminary forming operation.

FIG. 7 is a photograph showing an SEM observed image of Example 1 in the same view field as an Auger electron spectroscopy analyzing position.

FIG. 8 is a photograph of showing an Au mapping result obtained by Auger electron spectroscopy analysis of Example 1.

FIG. 9 is a photograph showing an Fe mapping result obtained by Auger electron spectroscopy analysis of Example 1.

FIG. 10 is a photograph showing an SEM observed image with the same view field as the position of Auger electron spectroscopy analysis of Comparative Example 2.

FIG. 11 is a photograph showing an Au mapping result obtained by Auger electron spectroscopy analysis of Comparative Example 2.

FIG. 12 is a photograph showing an Fe mapping result obtained by Auger electron spectroscopy analysis of Comparative Example 2.

FIG. 13 is a graph showing a relationship between a draft x at a time of cladding performed by a cold rolling work and a limit plate thickness residual rate y.

FIG. 14 is a sectional view schematically showing a portion of a fuel cell stack in a second embodiment of the present invention.

FIG. 15 is a constitution view showing an appearance of the fuel cell stack in the second embodiment of the present invention.

FIG. 16 is a perspective view of the fuel cell stack in the second embodiment of the present invention.

FIG. 17A and FIG. 17B are a side view of an electric automobile showing an appearance of the electric automobile on which a fuel cell stack is mounted, and a top view thereof in a third embodiment.

### BEST MODE FOR CARRYING OUT THE INVENTION

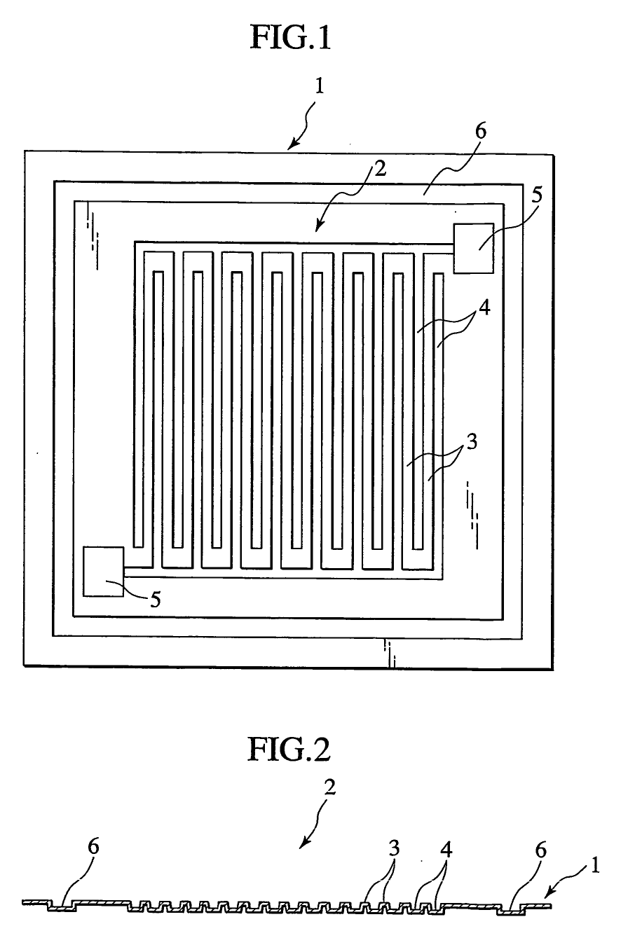

Hereinafter, a separator for a fuel cell, a method for manufacturing the separator, a fuel cell stack, and a fuel cell vehicle of various embodiments according to the present invention are described principally with reference to the accompanying drawings FIGS. 1 to 7 as an example of a fuel cell electric automobile mounted on a fuel cell stack.

### First Embodiment

First, a separator for a fuel cell and its related method of a first embodiment according to the present invention are described with an example of a separator for solid polymer type fuel cell with an interdigitated type flow path, with reference to FIG. 1 to FIG. 13, Table 1 and Table 2.

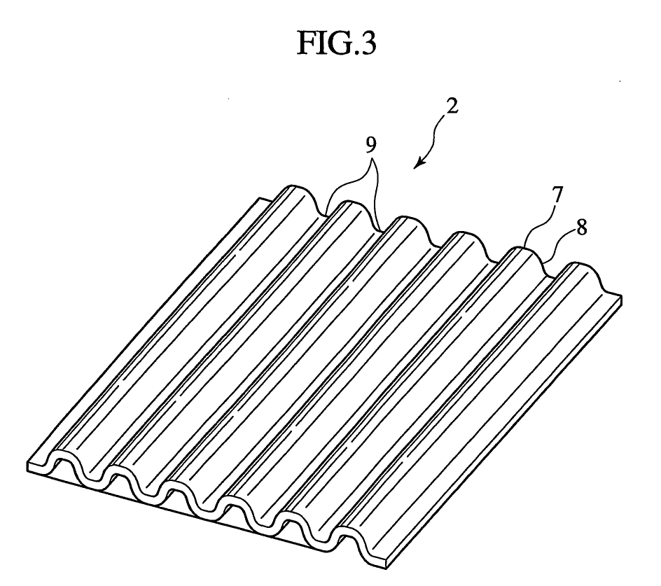

FIG. 1 is a top view of a gas flow path face side of a separator for a solid polymer type fuel cell on which an interdigitated flow path is formed, FIG. 2 is a schematic view of a sectional shape of the separator, and FIG. 3 is a schematic perspective view of a gas flow path portion of the separator.

As shown in FIG. 1, a separator for a solid polymer type fuel cell 1 has a central portion 2 serving as a power generating portion, which is formed in an undulation shape obtained by forming a convex rib 3 allowing current flow and a concave gas flow path groove 4 adjacent to the rib 3 alternately. The gas flow path groove 4 is connected to gas manifolds 5 formed at both ends of the central portion 2 on an orthogonal line. A bead portion 6 is formed on an outer peripheral edge of the separator 1 about a periphery of the central portion 2, and a sectional view of the separator 1 has a continuous corrugated shape, as shown in FIG. 2.

FIG. 3 is a perspective view of the gas flow path portion in the central portion 2 of the separator for a fuel cell 1. As shown in FIG. 3, a gas flow path groove bottom portion 9 is continuous on the central portion 2 of the separator for a fuel cell 1 from a rib flat portion 7 via a rib slope portion 8, and the rib flat portion 7 and the gas flow path groove bottom portion 9 are arranged substantially parallel to each other.

The separator for a fuel cell 1 with the above shape is constituted of a clad thin plate formed with a coating layer by performing an anti-corrosive and conductive surface treatment on both surfaces of a metal plate as an underlying base member.

The metal plate as the base member may be constituted of one type of alloy selected from a group of iron-base alloy, Ni-base alloy, industrial pure Ti, Ti-base alloy and stainless steel alloy, or an alloy obtained by a combination of at least two types thereof, and a separator for a fuel cell with excellent corrosion resistance and productivity can be provided at a lower cost by using such a type of alloy.

Among the above iron-base alloys, it is most preferable to use an austenite-base stainless steel plate such as SUS304 or SUS316, ferrite base stainless steel plate such as SUS430, so that a separator for a fuel cell with further excellent corrosion resistance and productivity can be provided at a lower cost.

The coating layer is a layer obtained by forming a precious metal layer with a thickness of 0.01 μm to 0.05 μm on a metal plate as an underlying base member to perform rolling thereon at a draft of 5% to 15%. The coating layer is preferably constituted of such precious metal as gold (Au), platinum (Pt) or silver (Ag). Among them, Au or Au alloy is most preferable. By forming the precious metal layer from Au or Au alloy, a separator for a fuel cell having not only excellent corrosion resistance and ductile property, and high electric conductivity, but also low contacting electric resistance with a constituent material such as an adjacent gas diffusion electrode can be obtained.

The plate thickness t4 of the clad thin plate of a peripheral portion of the separator, which has not been press-formed, is preferably set in a range of 0.05 mm to 0.10 mm. When the plate thickness t4 of the clad thin plate becomes less than 0.05 mm, the strength of the separator is lowered, and when the plate thickness t4 exceeds 0.10 mm, the weight thereof becomes heavy so that these separators are unsuitable for a moving vehicle such as an automobile. Further, the thickness of the precious metal layer is preferably set in a range of 0.01 μm to 0.05 μm.

Furthermore, in the above separator for a fuel cell, the thickness of the precious metal layer is preferably set in a range of 1/10000 to 1/1000 of the thickness of the metal plate. The reason for setting the thickness of the precious metal layer in this range is because, when the thickness of the precious metal layer becomes thinner than the range, the corrosion resistance is lowered and when it becomes thicker than the range, its cost becomes very high. By defining the precious metal layer to a thickness in the range, a separator for a fuel cell having excellent corrosion resistance and low contacting electric resistance with an adjacent constituent member can be provided at a lower cost.

The method for manufacturing the separator for a fuel cell 1 will be explained later. Prior to manufacturing the separator, first, a clad thin plate with a predetermined thickness (a plate thickness t4) is manufactured by performing an anti-corrosive and conductive surface treatment on both surfaces of a metal plate as an underlying base member to form coating layers. A sample obtained by applying a predetermined flat plastic strain on the clad thin plate with the plate thickness of t4 in a stepping manner is then manufactured, and the plate thickness of the separator, occurrence of fine cracks in the surface precious metal layer and presence/absence of exposure of the metal plate as the underlying base member due to occurrence of fine cracks are respectively measured. A limit plate thickness where reduction in corrosion resistance due to the exposure of the underlying base member can be neglected is obtained so that the plate thickness t2 of the thinnest portion in the rib shoulder portion is equal to at least the limit plate thickness.

In order to make accurate determination about occurrence of fine cracks in the surface layer precious metal layer and exposure of the underlying base member due to occurrence of fine crack, an observation should be performed using Auger electron spectroscopy analysis rather than EPMA (electron beam probe fine analysis) providing a deep detection depth or the like. In Auger electron spectroscopy, determination can be made by performing element mapping analysis about a principal element in the precious metal layer and a principal element in the underlying base member precious metal material with a magnitude of about 500 times to 5000 times and making observation about whether or not a portion where the precious metal element is not detected and a portion where the underlying member element is detected are coincident with each other in position and shape.

Regarding a sectional shape of the gas flow path groove 4 in a direction perpendicular to a direction of a flow path, it is assumed that a plate thickness of a rib central portion contacting with a gas diffusion layer is represented by t1, a plate thickness of the thinnest portion of a rib shoulder portion is represented by t2, a plate thickness of a slope portion is represented by t3, and a plate thickness of a peripheral portion where press forming work is not performed is represented by t4. In this case, it is preferable that the plate thickness t2 meets a relationship of t2≧t4×limit plate thickness residual rate. More specifically, it is preferable that the plate thickness t2 meets a relationship of t2≧0.7×t4, and it is particularly preferable that it meets t2≧0.74×t4.

The limit plate thickness residual rate indicates a value showing a ratio of a plate thickness after working to a plate thickness before working. The limit plate thickness residual rate has a value varying depending on a draft when a precious metal layer is formed on a metal plate surface and rolling work is performed to make clad. Assuming that a draft when rolling work is performed for making clad is x % and the limit plate thickness residual rate is y, it is preferable that the draft x and the limit plate thickness residual rate y meet a relationship of y=0.5+0.02x. More preferably, they meet a relationship of y=0.55+0.02x.

By limiting the plate thickness t2 in the above range, occurrence of fine cracks of the surface layer precious metal layer on the rib shoulder portion is prevented and exposure of the underlying base member due to occurrence of fine cracks is suppressed so that corrosion resistance can be prevented from lowering.

Further, when an outside radius of curvature in the vicinity of a measurement position on a side of a face contacting with the gas diffusion layer in the sectional shape of the gas flow path portion and an inside radius of curvature on a back surface are represented by Rout and Rin, it is preferable that Rout has a plus radius of curvature. Rout/(Rin+t2) is preferably 5 or less, and more preferably 1.5 or less. Rout/t2 is preferably 5 or less, and still more preferably 10 or less. Further, Rout/Rin is preferably 10 or less, and more preferably 2 or less. The reason for setting the minimum plate thickness of the rib shoulder portion, and the shape between the outside radius of curvature of the plate and the inside radius of curvature of the plate are defined in these ranges is because, when they deviate from the ranges, fine cracks occur in the precious metal layer as the surface layer and the metal plate as the underlying base member is exposed according to occurrence of fine cracks so that corrosion resistance is lowered.

Moreover, regarding the absolute value of the outside radius of curvature of the plate of the rib shoulder portion, Rout is preferably set to be 0.6 mm or less, and more preferably 0.5 mm. By setting Rout to 0.6 mm or less, occurrence of fine cracks in the surface layer precious metal layer is prevented so that exposure of the underlying base member due to occurrence of fine cracks can be suppressed completely.

It is also preferable that a relationship between the minimum plate thickness of the rib shoulder portion and the plate thickness of the rib slope portion on the separator section and a relationship between the plate thickness of the rib slope portion and the plate thickness of the rib top flat portion meet t2/t3≧0.74 and t3≧t1. By setting in such a range, occurrence of fine cracks in the surface layer precious metal layer and exposure of the underlying base member due to occurrence of fine cracks can be suppressed further effectively.

[Manufacturing Method of a Separator for a Fuel Cell]

The separator for a fuel cell 1 can be manufactured by the following manufacturing method.

As the metal plate which is the underlying base member, one alloy selected from a group consisting of iron-base alloy, Ni-base alloy, Ti-base alloy and stainless steel alloy or an alloy plate of a combination of two or more thereof is first prepared and precious metal layers with a thickness of 0.01 μm to 0.05 μm made of gold (Au) or the like are formed on both surfaces of the metal plate. Then, a clad thin plate is manufactured by rolling the metal plate at a draft of 5% to 15%. Though the rolling work is conducted at a draft of 5% to 15%, when the draft is less than 5%, damage in a surface metal layer becomes great and corrosion resistance is lowered. When the draft exceeds 15%, such a drawback arises that a sufficient ductility of a material cannot be secured in a press forming to a separator shape conducted later. In order to secure accuracy in the press forming conducted later, it is preferable that the draft is set in a range of 5% to 10%.

A method for forming a precious metal layer on a metal plate includes PVD process such as vacuum deposition, sputtering, ion plating, CVD process, and a plating process such as electroplating, electroless plating. Further, the rolling is for improving close adhering force between a metal plate and a precious metal layer to make a porous structure of the precious metal layer fine and for closing pin holes to improve corrosion resistance, and it can be performed using a mill roll generally used.

After the manufactured clad thin plate is cut to a predetermined size and the cut clad thin plate is coated with polymer material such as polyester, polyethylene, the clad thin plate coated with polymer material is subjected to bulging-formation to produce a separator for a fuel cell. The bulging-formation will be explained later.

By using the clad thin plate obtained by forming the precious metal layers on the metal plate, a contact resistance between the separator and a constitution material such as a gas diffusion electrode adjacent thereto can be suppressed to a lower level, so that a separator for a fuel cell which can maintain a power generating efficiency of the fuel cell and has an excellent endurance reliability can be obtained at a lower cost. By constituting a clad thin plate using the above-described materials, even if the fuel cell is downsized, a high strength can be maintained, so that a fuel cell with a high output density can be obtained by thinning the separator for a fuel cell. The bulging-formation will be explained next.

The bulging-formation is a multi-stage press formation including two or more press forming steps for changing the sectional shape of the gas flow path portion to a predetermined shape. The multi-stage press formation has one or two preliminary press forming steps for elongating the clad thin plate and a finishing press forming step for achieving the predetermined shape. By achieving sufficient elongation of the clad thin plate in the preliminary press forming step(s) in advance, compression stress acting in a direction orthogonal to the gas flow path groove on a surface side of the clad thin plate can be sustained during bending work of the rib shoulder portion at the finishing press forming step, so that occurrence of fine cracks in the surface layer precious metal layer and exposure of the underlying base member due to occurrence of fine cracks can be suppressed.

More specifically, the formation height after the preliminary press forming step(s) is preferably at least 1.25 times the formation height of a product, more preferably at least 1.3 times. Though the formation height after the preliminary press forming is defined to be at least 1.25 times the formation height of the product, if it is less than 1.25 times, sufficient elongation of material cannot be achieved. As a result, the predetermined shape cannot be achieved in the finishing press forming step conducted thereafter.

Regarding a surface of the rib shoulder portion of separator section with a plate thickness of t2, it is preferable that fine cracks do not occur in the precious metal layer so that the metal plate as the underlying base member is not exposed, or even if fine cracks occur in the precious metal layer so that the metal plate is exposed, an area ratio of the exposed metal plate to the entire metal plate is suppressed to 1% or less. By suppressing the area ratio of the exposed metal plate to 1% or less even in the exposure of the metal plate, a corrosion resistance after press forming can be kept equal to the state of the clad thin plate before press forming or deterioration of corrosion resistance can be made negligible.

By directly suppressing the frequency of fine cracks in the surface layer precious metal layer occurring at the rib shoulder portion with the flow path section in this manner, the degree of reduction of corrosion resistance due to occurrence of fine cracks in the surface layer precious metal layer of the and exposure of the underlying base member due to occurrence of fine cracks can be suppressed to a completely negligible range.

Respective separators were manufactured and their corrosion resistances were evaluated below according to Examples 1 to 9, and Comparative Examples 1 to 4.

### EXAMPLES

### Example 1 to Example 5

In Examples 1 to 5, clad thin plates with a thickness of 0.1 mm prepared in the following manner were used. After Au plate with a thickness of 0.03 μm was applied on both surfaces of a thin plate material of SUS316L solution heat treatment (BA) material with a thickness t of 0.11 mm, the plated thin plate was subjected to cold rolling work at a draft of 10%, thereby preparing the clad thin plate. In this connection, the plate thickness t4 of a separator peripheral portion in which the clad thin plate was not subjected to a press forming work was 0.1 mm.

The clad thin plate material was cut out to a size of 150 mm×150 mm, and an interdigitated type flow path with a gas flow path portion (active area) size of 100 mm×100 mm was bulging-formed so as to manufacture a separator.

In Examples 1 to 5, separators with various sectional shapes were manufactured while changing an elongating amount of a clad thin plate of a preliminary press forming step, namely, changing a formation height at a time of the preliminary press formation.

### Example 6 to Example 9

In Examples 6 and 7, clad thin plates with a thickness of 0.1 mm prepared in the following manner were used. Au plate with a thickness of 0.03 μm was applied on both surfaces of a thin plate material of SUS316L solution heat treatment (BA) material with a thickness t of 0.11 mm and the plated thin plate was subjected to cold rolling work at a draft of 7.5%, thereby preparing the clad thin plate. In Examples 8 and 9, clad thin plates with a thickness of 0.1 mm prepared in the following manner were used. Au plating with a thickness of 0.03 μm was applied to both surfaces of a thin plate material of SUS316L solution heat treatment (BA) material with a thickness t of 0.11 mm and the plated thin plate was subjected to cold rolling work at a draft of 5.0%, thereby preparing the clad thin plate.

### Comparative Example 1 to Comparative Example 4

In these Comparative Examples, separators were manufactured in a similar manner as the Examples 1 to 9, and the separators had various sectional shapes obtained by changing the draft at a time of clad rolling and changing a formation height at a time of preliminary press forming.

Regarding each of the separators obtained from the above Examples 1 to 9 and Comparative Examples 1 to 4, after a gas flow path portion center portion thereof was cut out and embedded in polymer material such as polyester, a section of the center portion in a direction orthogonal to a flow path of the gas flow path portion was exposed by polishing and the section was observed with an optical microscope.

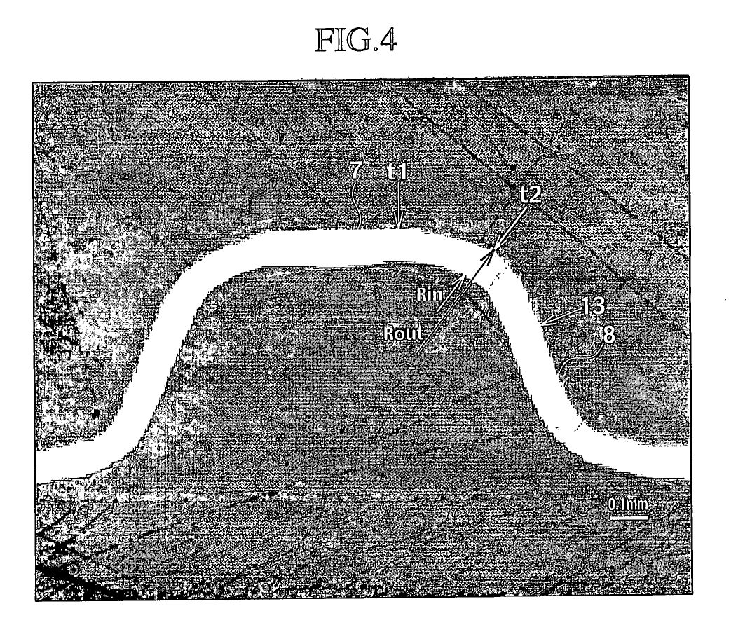

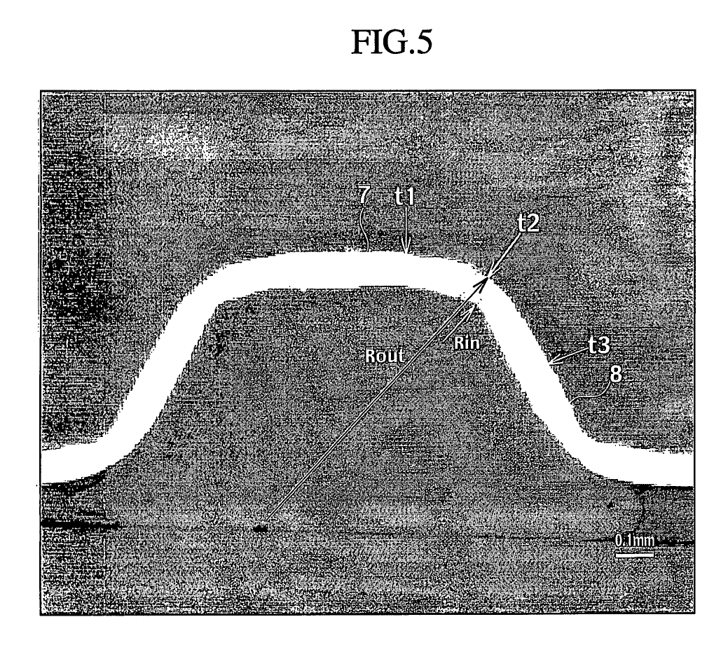

As a result of observing the sections of the respective separators, representative examples of sectional optical microscopic photographs are shown in FIG. 4 to FIG. 6.

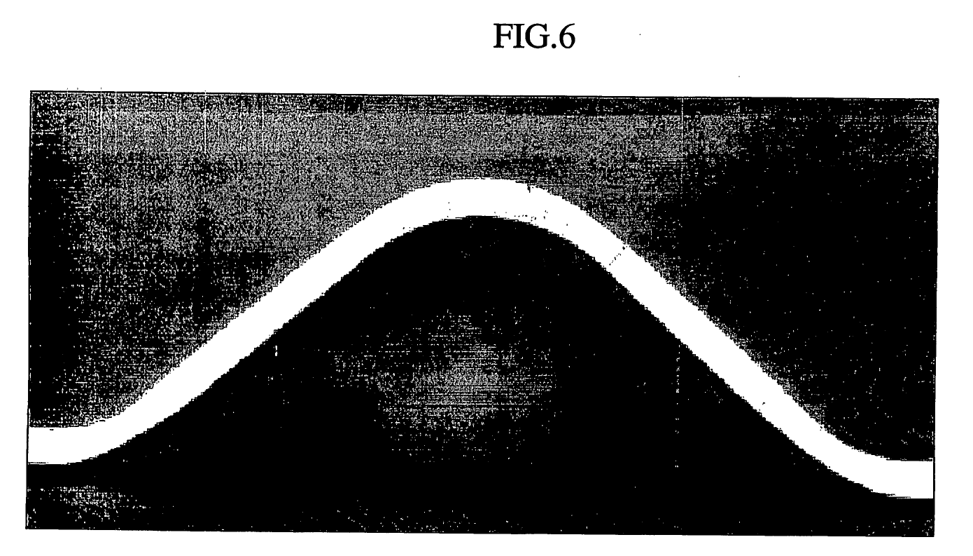

FIG. 4 is an optical microscopic photograph showing a sectional shape of a gas flow path portion of the separator of Example 1. FIG. 5 is an optical microscopic photograph showing a sectional shape of a gas flow path portion of the separator of Comparative Example 2. FIG. 6 is an optical microscopic photograph showing a sectional shape of a separator after completion of a preliminary press forming. The section of each of the separators shown in FIG. 4 to FIG. 6 was observed, and the plate thickness t1 of the rib flat portion 7 positioned at a central portion of the rib, the plate thickness t2 of the thinnest portion of the rib shoulder portion, and the plate thickness t3 of the rib slope portion 8 on the side of a face of the separator contacting with the gas diffusion layer were respectively measured. An outside corner portion radius of curvature Rout in the vicinity of the measuring portion and a corner portion radius of curvature Rin on an inside corner portion on a back side of the separator that has the smallest radius of curvature were simultaneously measured. Various parameters are calculated based on the measured values, and the calculated values and the sizes of the separators are shown in Table 1 and Table 2.

TABLE 1

| | | Preliminary press | | | | | | | |
|---|---|---|---|---|---|---|---|---|---|
| | | forming step | | | Preliminary | | | | |
| | | Preliminary | | Product | formation | Product shape of separator | | | |
| | Clad | formation | Number of | formation | height/product | Plate thickness of each | | | |
| | draft | height | preliminary | height | formation | portion [mm] | | | |
| | [%] | [mm] | forming steps | [mm] | height | t1 | t2 | t3 | t4 |
| Example 1 | 10.0 | 0.82 | One stage | 0.63 | 1.3052 | 0.079 | 0.076 | 0.091 | 0.101 |
| Example 2 | 10.0 | 0.83 | One stage | 0.61 | 1.3547 | 0.086 | 0.076 | 0.088 | 0.101 |
| Example 3 | 10.0 | 0.85 | Two stages | 0.62 | 1.3688 | 0.083 | 0.080 | 0.088 | 0.101 |
| Example 4 | 10.0 | 0.80 | One stage | 0.63 | 1.2630 | 0.084 | 0.076 | 0.084 | 0.101 |
| Example 5 | 10.0 | 0.75 | One stage | 0.59 | 1.2671 | 0.074 | 0.072 | 0.091 | 0.101 |
| Example 6 | 7.5 | 0.80 | One stage | 0.61 | 1.3115 | 0.085 | 0.078 | 0.087 | 0.100 |
| Example 7 | 7.5 | 0.73 | One stage | 0.58 | 1.2586 | 0.085 | 0.068 | 0.089 | 0.100 |
| Example 8 | 5.0 | 0.80 | One stage | 0.61 | 1.3115 | 0.084 | 0.080 | 0.088 | 0.100 |
| Example 9 | 5.0 | 0.70 | One stage | 0.58 | 1.2069 | 0.082 | 0.064 | 0.088 | 0.100 |
| Comparative | 10.0 | 0.75 | One stage | 0.61 | 1.2346 | 0.084 | 0.067 | 0.088 | 0.101 |
| Example 1 | | | | | | | | | |
| Comparative | 10.0 | 0.70 | One stage | 0.58 | 1.2038 | 0.084 | 0.064 | 0.089 | 0.101 |
| Example 2 | | | | | | | | | |
| Comparative | 7.5 | 0.70 | One stage | 0.61 | 1.1475 | 0.083 | 0.065 | 0.087 | 0.100 |
| Example 3 | | | | | | | | | |
| Comparative | 5.0 | 0.65 | One stage | 0.61 | 1.0656 | 0.084 | 0.059 | 0.089 | 0.101 |
| Example 4 | | | | | | | | | |

| | Product shape of separator | | | | | | | | |
|---|---|---|---|---|---|---|---|---|---|
| | Shoulder | | | | | | | | |
| | portion radius | | | | | | | | |
| | of curvature | | Plate thickness/curvature parameter | | | | | | |
| | [mm] | | | | Rout/ | Rout/ | Rout/ | | |
| | Rin | Rout | t2/t4 | Rin + t2 | (Rin + t2) | t2 | Rin | t1/t3 | t2/t3 |
| Example 1 | 0.228 | 0.36 | 0.76 | 0.30 | 1.19 | 4.76 | 1.59 | 0.87 | 0.84 |
| Example 2 | 0.145 | 0.28 | 0.76 | 0.22 | 1.26 | 3.67 | 1.93 | 0.97 | 0.87 |
| Example 3 | 0.172 | 0.27 | 0.79 | 0.25 | 1.07 | 3.38 | 1.57 | 0.94 | 0.91 |
| Example 4 | 0.104 | 0.49 | 0.75 | 0.18 | 2.72 | 6.45 | 4.70 | 1.00 | 0.90 |
| Example 5 | 0.067 | 0.60 | 0.72 | 0.14 | 4.31 | 8.32 | 8.92 | 0.82 | 0.80 |
| Example 6 | 0.120 | 0.51 | 0.78 | 0.20 | 2.58 | 6.54 | 4.25 | 0.98 | 0.90 |
| Example 7 | 0.065 | 0.62 | 0.68 | 0.13 | 4.66 | 9.12 | 9.54 | 0.96 | 0.76 |
| Example 8 | 0.110 | 0.50 | 0.80 | 0.19 | 2.63 | 6.25 | 4.55 | 0.95 | 0.91 |
| Example 9 | 0.065 | 0.60 | 0.64 | 0.13 | 4.65 | 9.38 | 9.23 | 0.93 | 0.73 |
| Comparative | 0.062 | 0.76 | 0.66 | 0.13 | 5.86 | 11.30 | 12.17 | 0.95 | 0.76 |
| Example 1 | | | | | | | | | |
| Comparative | 0.052 | 2.37 | 0.64 | 0.12 | 20.34 | 36.72 | 45.60 | 0.93 | 0.72 |
| Example 2 | | | | | | | | | |
| Comparative | 0.074 | 1.20 | 0.65 | 0.14 | 8.63 | 18.46 | 16.22 | 0.95 | 0.75 |
| Example 3 | | | | | | | | | |
| Comparative | 0.052 | 3.12 | 0.58 | 0.11 | 28.13 | 52.88 | 60.09 | 0.93 | 0.66 |
| Example 4 | | | | | | | | | |

TABLE 2

| | | | Corrosion |
|---|---|---|---|
| | Stress in direction | Underlying | resistance |
| | orthogonal to gas | base | deterioration |
| | flow path groove | member | magnitude |
| | direction during rib | exposure | to clad material |
| | shoulder bending work | area ratio [%] | before formation |
| Example 1 | Compression | 0.4 | 1.20 |
| Example 2 | Compression | 0.3 | 1.15 |
| Example 3 | Compression | 0.1 | 1.05 |
| Example 4 | Compression | 0.6 | 1.30 |
| Example 5 | Compression | 1.0 | 1.49 |
| Example 6 | Compression | 0.2 | 1.10 |
| Example 7 | Compression | 0.9 | 1.45 |
| Example 8 | Compression | 0.3 | 1.15 |
| Example 9 | Compression | 0.7 | 1.35 |
| Comparative | Tension | 8.4 | 5.20 |
| Example 1 | | | |
| Comparative | Tension | 19.0 | 10.50 |
| Example 2 | | | |
| Comparative | Tension | 3.0 | 2.00 |
| Example 3 | | | |
| Comparative | Tension | 5.0 | 2.50 |
| Example 4 | | | |

As shown in Table 1 and Table 2, in each of the separators in Examples 1 to 9, a ratio of the preliminary formation height to the product formation height was at least 1.25, and each shape of the separator after press forming satisfied a relationship of t2≧0.7×t4.

In Examples 1 to 9 and Comparative Examples 1 to 4 shown in Table 1, a draft x % at a time of rolling work for making clad was variously changed.

In each separator in Examples 1 to 9 and Comparative Examples 1 to 4, its central portion of a gas flow path portion contacting with a gas diffusion layer was cut out, and occurrence of fine cracks in the surface layer precious metal layer in the rib shoulder portion and exposure of the underlying base member due to occurrence of fine cracks were examined. Then, after the cut-out portion of the separator was subjected to ultrasonic cleaning with n-hexane, Auger electron spectroscopy analysis was performed on the cut-out portion. In the Auger electron spectroscopy analysis, using field emission type Auger electron spectroscopy analyzer (Model 1680 manufactured by Physical Electronics Industries, Inc.), measurement was made under the conditions of an electron beam accelerating voltage of 10 kV, a beam diameter Φ of 35 nm, with a measurement area of 160 μm×200 μm (500 times), and 256×256 pixels. Under these measurement conditions, element mapping about Au and Fe being a main element of the underlying stainless steel base member was performed and SEM (a scanning type electron microscope) observed images with the same view field as the analysis position were acquired.

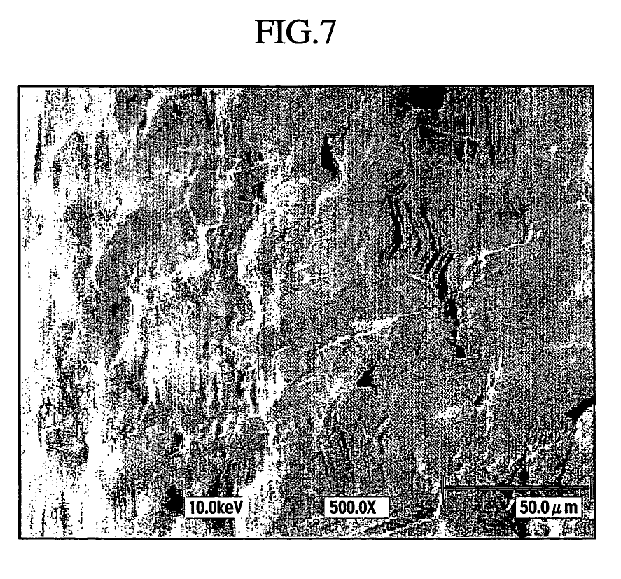

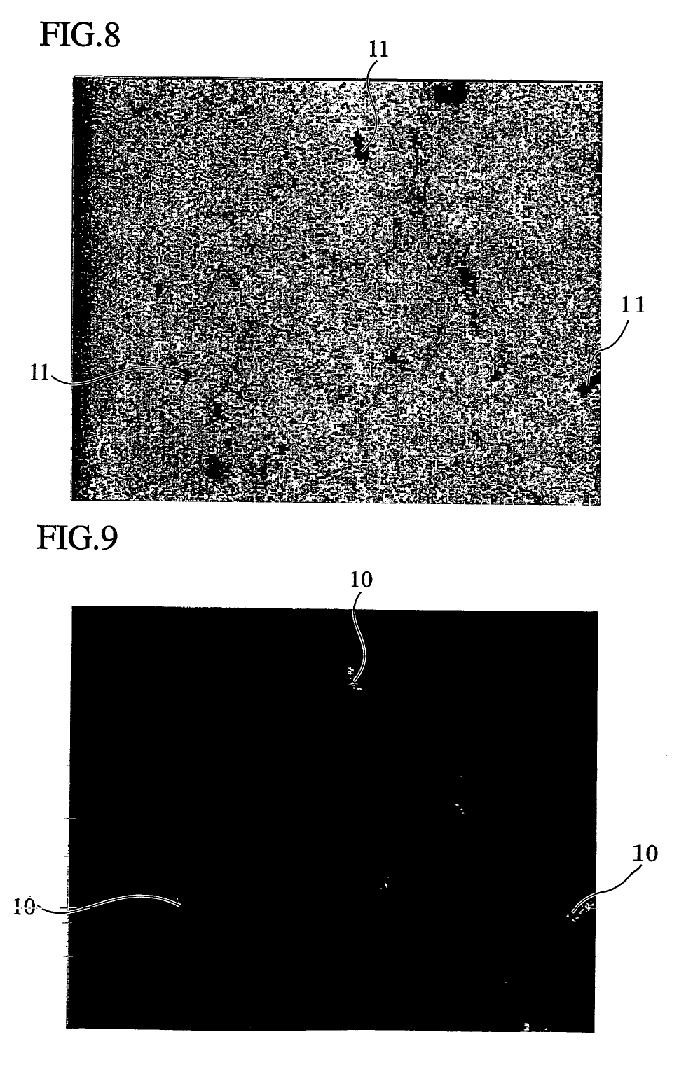

FIGS. 7 to 9 show the observed results of Example 1, FIG. 7 is a photograph showing an SEM observed image with the same view field as the analysis position in Example 1, FIG. 8 is a photograph showing an Au mapping result, and FIG. 9 is a photograph showing an Fe mapping result.

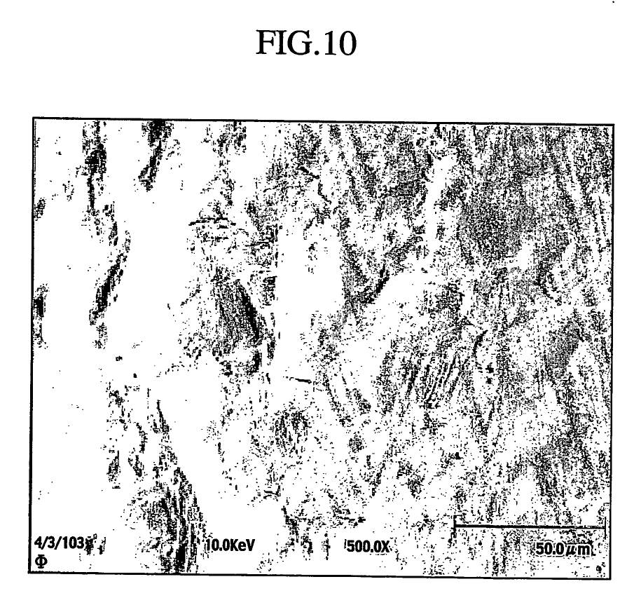

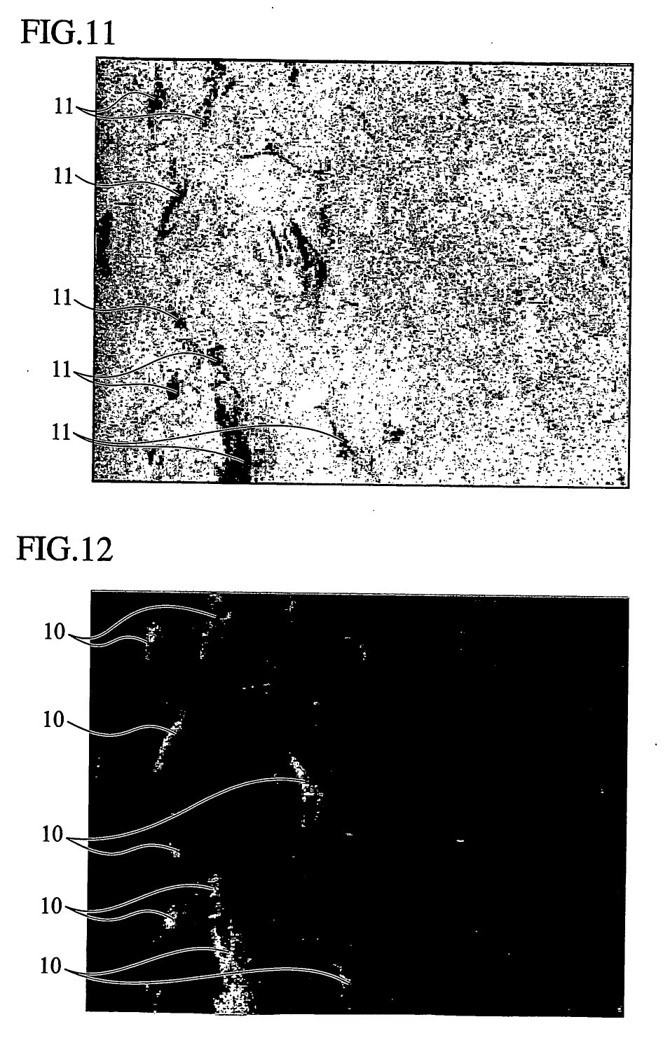

FIGS. 10 to 12 show observed results of Comparative Example 2, FIG. 10 is a photograph showing an SEM observed image with the same view field as the analysis position in Comparative Example 2, FIG. 11 is a photograph showing an Au mapping result, and FIG. 12 is a photograph showing an Fe mapping result. In each mapping shown in FIG. 8, FIG. 9, FIG. 11 and FIG. 12, the fact that Au or Fe element was detected from white portions 10, and Au or Fe element was not detected from black portions 11 is shown.

In the Auger electron spectroscopic analysis, the depth allowing information detection is several nanometers or so. For this reason, when the portions (the black portions 11) where Au was not detected from the Au mapping results shown in FIG. 8 and FIG. 11 and the portions (the white portions 10) where Fe was detected from the Fe mapping results shown in FIG. 9 and FIG. 12 are coincident with each other in position and shape, it is determined that the Au layer as a surface layer was cracked and the underlying stainless steel base member was exposed, as shown in the SEM observed images in FIG. 7 and FIG. 10.

In fact, viewing the observed image of the separator in Comparative Example 2, there were many coincident portions, in position and shape, of the portions (the black portions 11) where Au was not detected from the Au mapping result, as shown in FIG. 11 and the portions (the white portions 10) where Fe was detected from the Fe mapping result with the same view field, as shown in FIG. 12, and the lengths and widths of the coincident portions were respectively in a range of about 20 μm to 30 μm and in a range of about 5 μm to 10 μm. It was found that the Au layer was cracked and stainless steel as the underlying base member was exposed at a portion where the white portion 10 and the black portion 11 were coincident with each other. On the other hand, in the separator in Example 1, there are less portions where the portions (the black portions 11) where Au was not detected from the Au mapping result shown in FIG. 8 and the portions (the white portions 10) where Fe was detected from the Fe mapping result shown in FIG. 9 were coincident with each other in position and shape, and the lengths and widths of the coincident portions were respectively about several micro meters. For this reason, in the separator in Example 1, it was found that there was hardly a portion where the Au layer as the surface layer cracked and the stainless steel base member as the underlying base member was exposed.

[Measurement of Area Ratio]

The area ratio of a portion where the Au layer as the surface layer cracked so that the underlying stainless steel base member was exposed was measured from the SEM observed images shown in FIG. 7 to FIG. 12 and the mapping results. In the measurement of the area ratio, the area of a portion where the stainless steel as the underlying base member was exposed was measured, and the ratio thereof to the entire area of the separator surface was calculated to obtain an underlying base member exposure area ratio %. The result is shown in Table 1.

[Evaluation of Corrosion Resistance]

A central portion of the separator flow path portion obtained from each of Example 1 to Example 9 and Comparative Example 1 to Comparative Example 4 was cut out and the degree of lowering in corrosion resistance thereof was evaluated using a constant potential electrolytic test as an electro chemical approach.

In a fuel cell, a potential of at most about 1V is applied to the oxygen electrode side as compared with the hydrogen electrode side. The solid polymer electrolytic membrane is constituted to a polymer electrolytic membrane having proton exchanger in molecule, which causes to contain water up to a saturated state to utilize proton conductivity, and it develops strong acidic property. For this reason, in the constant potential electrolytic test, the solid polymer electrolytic membrane was held for a fixed time while being applied with a potential. A corrosive current density and an amount of metal ions eluted in a solution after the fixed time elapsed were measured, and the corrosion resistance of the separator was evaluated. The conditions for the constant potential electrolytic test included sulfuric acid of pH 2 as solution liquid property, a temperature of 80° C., a potential of 1Vvs SHE and the fixed time of 100 hours to be held. A test piece was manufactured such that a flag-shaped test piece was cut out so as to have an electrode portion of 3 cm square, an end face of the cut-out test piece and a back face thereof were sealed with masking material, and a surface side thereof had an electrode portion of 2.5 cm square. An amount of metal ions eluded in the solution after the test piece was held for 100 hours was determined according to ICP-mass analysis, and the corrosion resistance was evaluated on the basis of the an amount of eluded elements obtained by dividing the amount of eluded metal elements by the electrode area and the corrosive current density during test (a value [μA/cm²] obtained by dividing the amount of corrosive current by the electrode area).

From the result of the constant potential electrolytic test, a corrosive deterioration magnitude to the clad thin plate with a flat state before formed was obtained. Incidentally, the corrosive deterioration magnitude was a value obtained by measuring the eluded element amount per unit electrode area to divide the measured eluded element amount by the eluded element amount per unit electrode area in the flat state before forming. The results are shown in Table 1.

[Measurement of Limit Plate Thickness Residual Rate]

The limit plate thickness residual rate was obtained using each of Samples No. 1 to No. 20 shown below by the spherical head bulging test. As Samples No. 1 to Sample No. 20, thin plates of SUS316L solution heat treatment (BA) material with a thickness t of 0.11 mm used in each of the above Examples were used. More specifically, regarding Samples No. 1 to No. 8, a clad thin plate was manufactured by applying Au plate with a thickness t of 0.03 μm to both surfaces of a thin plate of SUS316L solution heat treatment (BA) material with a thickness t of 0.11 mm which was the same thickness as that used in each of Examples 1 to 5 and Comparative Example 2 and performing cold rolling work on the plated thin plate at a draft of 10% for clad.

Regarding Samples No. 9 to No. 14, a clad thin plate was manufactured in the same manner as Sample No. 1 to Sample No. 8 except that a thin plate of SUS316L solution heat treatment (BA) material with a thickness t of 0.11 mm which was the same thickness as that used in each of Example 6, Example 7 and Comparative Example 3 was used and the draft was set to 7.5%. Regarding Samples No. 15 to No. 20, a clad thin plate was manufactured in the same manner as Sample No. 1 to Sample No. 8 except that a thin plate of SUS316L solution heat treatment (BA) material with a thickness t of 0.11 mm which was the same thickness as that used in each of Example 8, Example 9 and Comparative Example 4 was used and the draft was set to 5%.

Clad thin plates of Samples No. 1 to No. 20 were then manufactured by imparting different loads on respective clad thin plate manufactured. Predetermined strains were imparted in a stepwise manner while changing a measurement position.

Regarding each clad thin plate of Samples No. 1 to No. 20, the plate thickness t2 of the rib shoulder portion of the gas flow path portion was measured and Auger electron spectroscopy analysis was performed on each clad thin plate. Incidentally, Auger electron spectroscopy analysis was conducted under the same conditions as the above described ones.

Regarding each clad thin plate of Samples No. 1 to No. 20, the degree of exposure of the stainless steel base member due to occurrence of fine cracks in the surface Au layer was observed. The results are shown in Table 3

TABLE 3

| | | Spherical head punch stretch forming test | | | | | |
|---|---|---|---|---|---|---|---|
| | | Spherical head | | | | | |
| | Clad | punch stretch | | | | Plate | |
| Sample | draft | forming test | Main | Sub- | Plane | thickness | Observation result of |
| No. | [%] | Load [kgf] | strain [%] | strain [%] | strain [%] | [mm] | fine crack occurrence |
| 1 | 10.0 | 560(cracking) | 26 | 14 | 43.6 | 0.062 | Remarkably occur |
| 2 | 10.0 | 560 | 23 | 11 | 36.5 | 0.069 | Occur |
| 3 | 10.0 | 560 | 22 | 11 | 35.4 | 0.071 | Occur |
| 4 | 10.0 | 500 | 19 | 11 | 32.1 | 0.074 | Slightly occur |
| 5 | 10.0 | 500 | 17 | 11 | 29.9 | 0.075 | Substantial non-occurrence |
| 6 | 10.0 | 450 | 16 | 11 | 28.8 | 0.076 | Substantial non-occurrence |
| 7 | 10.0 | 400 | 15 | 10 | 26.5 | 0.080 | Substantial non-occurrence |
| 8 | 10.0 | 300 | 9 | 9 | 18.8 | 0.084 | Substantial non-occurrence |
| 9 | 7.5 | 620(cracking) | 34 | 15 | 54.1 | 0.062 | Occur |
| 10 | 7.5 | 620 | 32 | 15 | 51.8 | 0.064 | Slightly occur |
| 11 | 7.5 | 620 | 22 | 15 | 40.3 | 0.069 | Substantial non-occurrence |
| 12 | 7.5 | 620 | 17 | 15 | 34.6 | 0.074 | Substantial non-occurrence |
| 13 | 7.5 | 620 | 14 | 14 | 30.0 | 0.077 | Substantial non-occurrence |
| 14 | 7.5 | 420 | 13 | 10 | 24.3 | 0.080 | Substantial non-occurrence |
| 15 | 5.0 | 720(cracking) | 36 | 17 | 59.1 | 0.060 | Slightly occur |
| 16 | 5.0 | 720 | 29 | 17 | 50.9 | 0.065 | Substantial non-occurrence |
| 17 | 5.0 | 520 | 26 | 11 | 39.9 | 0.070 | Substantial non-occurrence |
| 18 | 5.0 | 620 | 17 | 15 | 34.6 | 0.073 | Substantial non-occurrence |
| 19 | 5.0 | 520 | 17 | 11 | 29.9 | 0.077 | Substantial non-occurrence |
| 20 | 5.0 | 520 | 13 | 11 | 25.4 | 0.079 | Substantial non-occurrence |

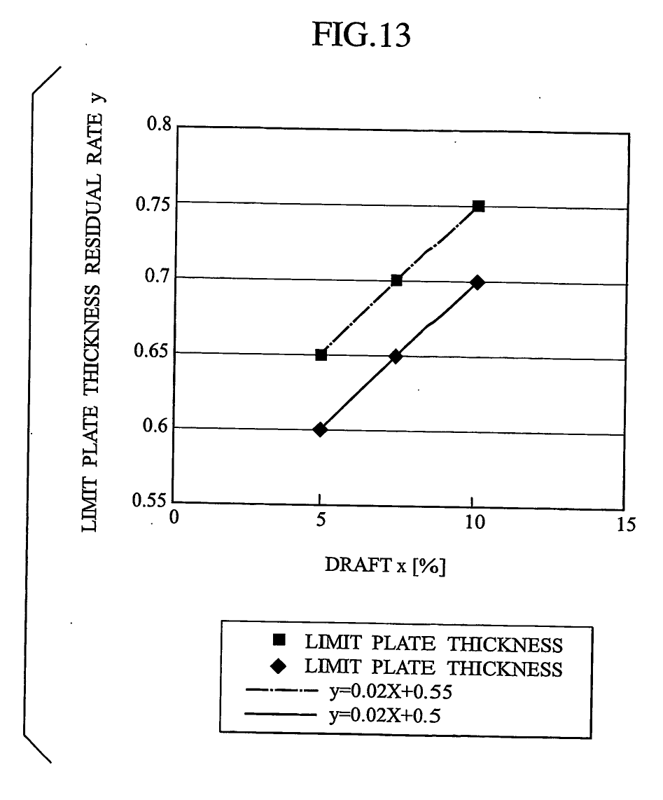

Further, the results shown in Table 3 and the results shown in Table 1 and Table 2 were correlated with each other. The limit plate thickness was obtained from a relationship the plate thickness residual rate and exposure of the metal plate as the base member due to rapture of the surface layer precious metal layer when plane strain was applied to the clad thin plate formed with the precious metal layer. As shown in Table 3, when the draft was first set to 10%, fine cracks extremely slightly occurred in the clad thin plate of Sample No. 4, but fine cracks did not occur substantially in the clad thin plate of Sample No. 5. As a result, it was found that occurrence limit of fine cracks was the plane strain of 30%. Since the plate thickness of Sample No. 5 was 0.075 mm, and the thickness of the clad thin plate before load was applied was 0.10 mm, the limit plate thickness was in a range of 0.75 times the thickness before load was applied. From these observed results, it was found that the limit plate thickness of the clad thin plate was 0.075 mm. Similarly, it was found that, in Sample No. 9 to Sample No. 14 where the draft was set to 7.5%, the limit plate thickness of the clad thin plate was 0.069 mm, and in Sample No. 15 to Sample No. 20 where the draft was set to 5.0%, the limit plate thickness of the clad thin plate was 0.065 mm. A limit plate thickness residual rate y was obtained from the measurement result of each limit plate thickness, and a relationship thereof with a draft [%] of a clad thin plate was graphically shown in FIG. 13 with a one-dotted chain line. It was found that the draft and the limit plate thickness residual rate meet the relationship of y=0.55+0.02x in the one-dotted chain line shown in FIG. 13.

Further, regarding Samples No. 1 to No. 14, a limit plate thickness in an allowable range at each draft was obtained from Table 2. The limit plate thickness in the allowable range in each clad thin plate of Samples No. 1 to No. 8 was 0.071 mm, the limit plate thickness in the allowable range in each clad thin plate of Samples No. 9 to No. 14 was 0.064 mm, and the limit plate thickness in the allowable range in each clad thin plate of Samples No. 15 to No. 20 was 0.060 mm. The limit plate thickness residual rate y was obtained from these limit plate thicknesses in the allowable range, and a relationship thereof with a draft [%] of a clad thin plate was graphically shown in FIG. 13 with a solid line. It was found that the draft and the limit plate thickness residual rate meet the relationship of y=0.5+0.02x in the solid line shown in FIG. 13.

Then, by setting the minimum plate thickness t2 on the rib shoulder portion of the gas flow path portion to a thickness equal to or more than the limit plate thickness, occurrence of fine cracks is prevented in the precious metal layer of the surface layer on the rib shoulder portion of the gas flow path portion, and exposure of the metal layer as the underlying base member due to occurrence of fine cracks can be reduced so that corrosion resistance of the separator can be prevented from lowering.

As described above, by making comparison between Examples 1 to 9 and Comparative Examples 1 to 4 with each other to define the plate thickness residual rate of the thinnest portion of the rib shoulder portion on the gas flow path portion, the relationship between the outside curvature and the inside curvature of the rib shoulder portion, and the plate thickness of the thinnest portion, and the relationship between the outside curvature of the shoulder portion and plate thickness of each portion on the gas flow path section, occurrence of fine cracks in the precious metal layer of the surface layer and the exposure amount of the underlying base member according to occurrence of fine cracks can be suppressed so that corrosion resistance can be prevented from lowering.

As explained above, according to this embodiment, by setting the rib shoulder portion on the gas flow path portion of the separator to a predetermined thickness, the corrosion resistance can be prevented from lowering and the power generating efficiency of the fuel cell can be improved by reducing the contact resistance between the separator and the gas diffusion electrode.

### Second Embodiment

Next, in this embodiment, a unit cell was formed using the separator for a fuel cell manufactured in the first embodiment, a fuel cell stack was formed stacking a plurality of unit cells, and then a fuel cell assembly was constituted.

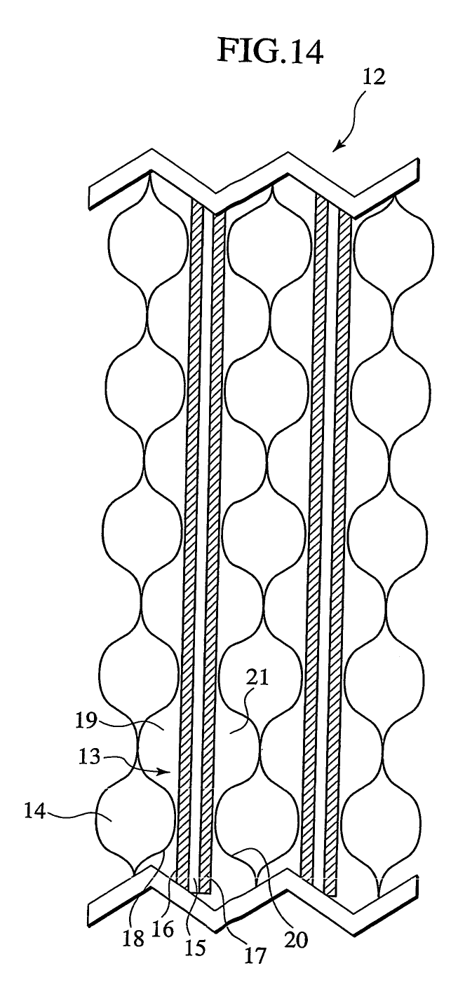

FIG. 14 is a sectional view schematically showing one portion of a fuel cell stack. As shown in FIG. 14, a fuel cell stack 12 is constituted by stacking a plurality of unit cells 13, and has a bipolar plate structure where cooling water flow paths 14 are formed between adjacent unit cells 13. Each unit cell 13 is obtained by forming a gas diffusion layer 16 having an oxidizing agent electrode and a gas diffusion layer 17 having a fuel electrode on both faces of a sold polymer type electrolytic membrane 15 to make a membrane electrode joined body, disposing an oxidizing agent electrode side separator 18 on the side of the oxidizing agent electrode of the membrane electrode joined body to form an oxidizing agent gas flow paths 19 therein, and disposing a fuel electrode side separator 20 on the side of the fuel electrode of the membrane electrode joined body to form fuel gas flow paths 21 therein.

As the solid polymer type electrolytic membrane 15, a perfluorocarbon copolymer membrane (Trade Name: Nafion1128 (Registered Trademark), Dupont Kabushiki Kaisha) or the like can be used.

The fuel cell stack 12 can be assembled according to the following procedure, for example.

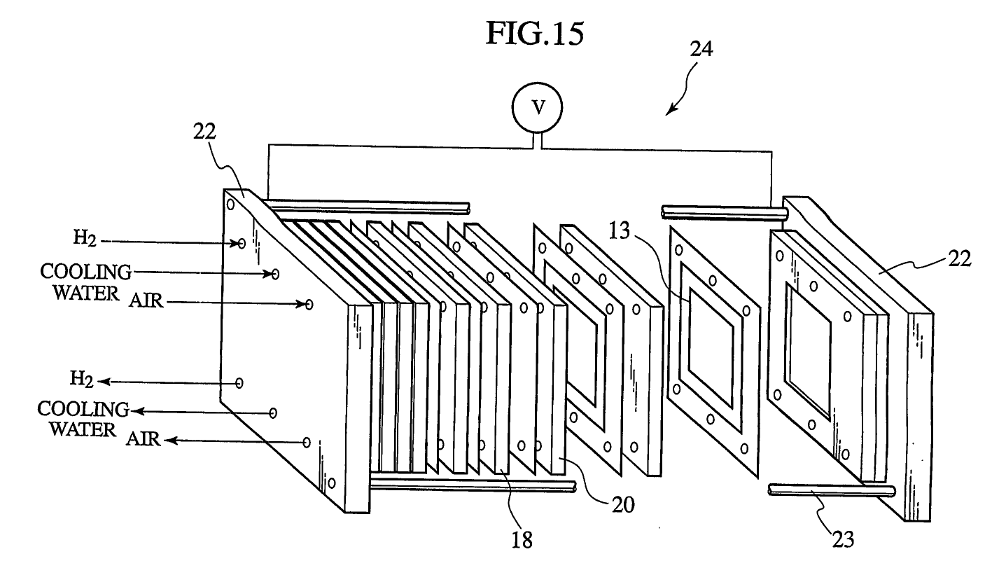

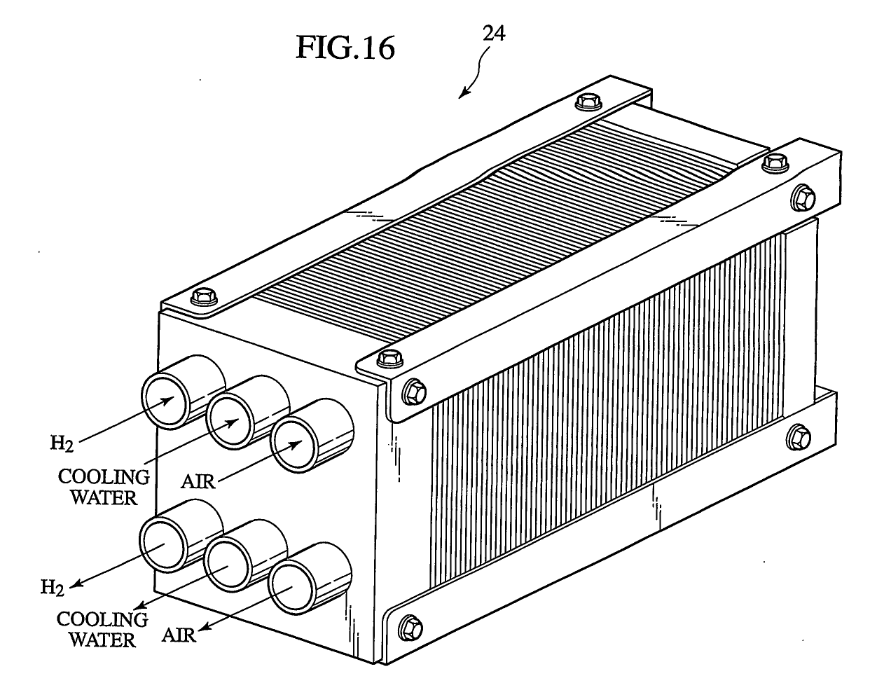

The oxidizing agent electrode side separator 18 and the fuel electrode side separator 20 are first prepared, and ribs of the respective separators 18, 20 are caused to abut on each other so that the cooling water flow paths are formed between the separators. The membrane electrode joined body provided with the solid polymer electrolytic membrane 15 and the respective gas diffusion layers 16, 17 having the oxidizing agent electrode and the fuel electrode is stacked on the separators 18, 20 caused to abut on each other, and the separators 18, 20 and the membrane electrode joined body are alternately superimposed plural times to make a stack. As shown in FIG. 15, after stacked, end flanges 22 are disposed at both ends of the stack, and outer peripheral portion thereof is fastened with fastening bolts 23, so that a fuel cell stack 24 is constituted. FIG. 16 is a perspective view of the fuel cell stack 24.

According to the second embodiment, by assembling a fuel cell stack using the separator for a fuel cell according to this embodiment of the present invention, a fuel battery having a compact fuel cell stack with a high efficiency can be provided.

Further, according to the second embodiment, a high power generating efficiency can be maintained without lowering a power generating efficiency and a fuel cell stack can be reduced in size.

### Third Embodiment

Next, in this embodiment, as one example of fuel cell vehicles, a fuel battery electric automobile using a fuel battery including the fuel cell battery manufactured according to the second embodiment as a power source will be explained.

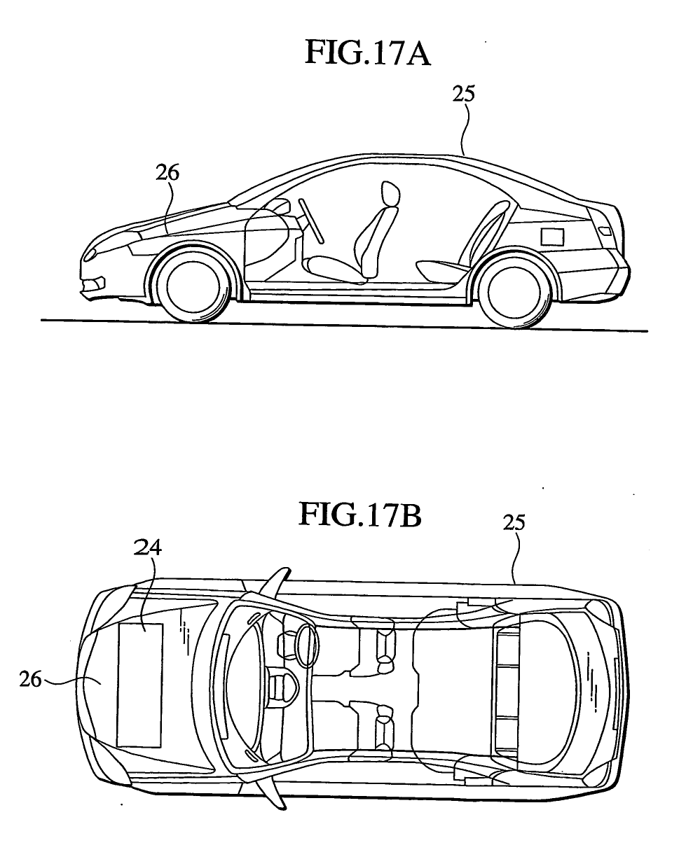

FIG. 17A is a side view showing an appearance of an electric automobile on which a fuel cell stack is mounted and FIG. 17B is a top view of the appearance of the electric automobile shown in FIG. 17A. As shown in FIG. 17B, an engine compartment section 26 defined by combining left and right front side members, and the left and right hood ridges, a dash lower member coupling the left and right hood ridges including the front side members is formed at a front section of a vehicle body 25. In the electric automobile according to this embodiment of the present invention, the fuel cell stack 24 is mounted inside the engine compartment section 26.

According to the third embodiment, by mounting a fuel cell stack, with a high power generating efficiency to which the fuel cell separator according to the embodiment of the present invention is applied, on a vehicle such as an automobile, fuel consumption savings and energy efficiency of fuel cell electric vehicles can be achieved.

According to this embodiment, by mounting a downsized and light-weighted fuel cell stack on a vehicle, the weight of the vehicle can be reduced to achieve fuel consumption savings and a longer traveling distance can be achieved.

Further, according to this embodiment, by mounting a downsized fuel cell stack on a mobile vehicle or the like, a broader interior space can be utilized, and a high flexibility for styling can be secured.

The entire content of a Patent Application No. TOKUGAN 2003-330633 with a filing date of Sep. 22, 2003 in Japan and the entire content of a Patent Application No. TOKUGAN 2004-162988 with a filing date of Jun. 1, 2004 in Japan is hereby incorporated by reference.

Although the invention has been described above by reference to certain embodiments of the invention, the invention is not limited to the embodiments described above will occur to those skilled in the art, in light of the teachings. The scope of the invention is defined with reference to the following claims.

### INDUSTRIAL APPLICABILITY

As set forth above, according to the invention, since the rib shoulder portion on the gas flow path portion of the separator is formed to a predetermined thickness and the contact resistance between the separator and the gas diffusion electrode is reduced, it is possible to prevent from lowering the corrosion resistance and to improve the power generating efficiency of the fuel cell. As a result, the fuel cell can be applied to the electric automobiles, airplanes requiring electric energy, or to other machines.

Therefore, such an application of the present invention can be expected in a wide range.

1. A separator for a fuel cell comprising: a corrugated or undulated gas flow path portion formed on central portion of a clad thin plate; and
a flat portion formed on an outer periphery of the central portion, wherein
the clad thin plate is obtained by applying rolling work on a metal plate whose surface is covered with a precious metal layer at a draft of 5% to 15% to make clad,
a limit plate thickness residual rate indicating a boundary limit in which cracking of the precious metal layer in the clad thin plate and reduction of corrosion resistance due to exposure of the metal plate are negligible is obtained in advance, wherein
regarding a sectional shape in a direction orthogonal to a flow path of the gas flow path portion, when a plate thickness of a rib central portion contacting with a gas diffusion layer is represented as t1, a plate thickness of the thinnest portion of a rib shoulder portion is represented as t2, a plate thickness of a rib slope portion is represented as t3, and a plate thickness of a peripheral portion of the separator is represented as t4, a relationship of t2≧t4×limit plate thickness residual rate is satisfied.

2. The separator for a fuel cell according to claim 1, wherein the limit plate thickness residual rate is a limit value at which lowering of corrosion resistance due to cracks of the precious metal layer of the clad thin plate and exposure of the metal plate is negligible, which can be obtained by, regarding a sample obtained by applying plane strain to the clad thin plate to apply stepwise plane plastic strains to the clad thin plate, measuring respective plate thickness residual rates in respective steps, observing presence/absence of fine cracks in the precious metal layer and exposure of the metal plate, and measuring a corrosion resistance deterioration ratio.

3. The separator for a fuel cell according to claim 1, wherein when the draft at the time of the rolling work for making clad is x [%] and the limit plate thickness residual rate is y, a relationship of y=0.5+0.02x is satisfied.

4. The separator for a fuel cell according to claim 1, further satisfying a relationship of t2≧t4×0.7.

5. The separator for a fuel cell according to claim 1, wherein when an outside corner portion radius of curvature in the vicinity of a measurement position on the side of the sectional shape of the gas flow path portion contacting with the gas diffusion layer is Rout and a corner portion radius of curvature of a portion of an inside corner portion whose radius of curvature is the smallest on the side of a back face thereof is Rin,
a relationship where Rout is positive (Rout portion is a convex curvature), Rout/(Rin+t2) is 5 or less, Rout/t2 is 10 or less, and Rout/Rin is 10 or less is satisfied.

6. The separator for a fuel cell according to claim 1, wherein Rout is 0.6 mm or less.

7. The separator for a fuel cell according to claim 1, further satisfying a relationship of t2/t3≧0.75 and t3≧t1.

8. The separator for a fuel cell according to claim 1, wherein the metal plate is one type of alloy selected from a group consisting of iron-base alloy, Ni-base alloy, industrial pure Ti, and Ti-base alloy and an alloy of a combination of at least two alloys selected therefrom.

9. The separator for a fuel cell according to claim 1, wherein the metal plate is austenite-base stainless steel or ferrite-base stainless steel.

10. The separator for a fuel cell according to claim 1, wherein the precious metal layer is made from Au or Au alloy.

11. The separator for a fuel cell according to claim 1, wherein the plate thickness t4 of the clad thin plate is in a range of 0.05 mm to 0.1 mm, the thickness of the precious metal layer is in a range of 0.01 μm to 0.05 μm, and the thickness of the precious metal layer is 1/10000 to 1/1000 of the thickness of the clad thin plate.

12. The separator for a fuel cell according to claim 1, wherein, on a surface of the rib shoulder portion of the sectional shape and the portion with the plate thickness t2, the precious metal layer is not cracked so that the metal plate as the underlying base member is not exposed, or even if the precious metal layer is cracked so that the metal plate as the underlying base member is exposed, an area ratio of the exposed metal plate to the whole area of the metal plate is 1% or less.

13. A fuel cell stack, comprising a membrane electrode joined body formed on both surfaces of an electrolytic membrane with an oxidizing agent electrode and a fuel electrode, an oxidizing agent electrode side separator disposed on the side of the oxidizing agent electrode of the membrane electrode joined body, and a fuel electrode side separator disposed on the side of the fuel electrode of the membrane electrode joined body, in which a plurality of unit cells formed with an fuel gas flow path and an oxidizing gas flow path between the membrane electrode joined body and the respective separators are stacked, and a cooling water flow path is formed between the respective unit cells, wherein each of the oxidizing agent electrode side separator and the fuel electrode side separator is the separator for a fuel cell according to claim 1.

14. A fuel cell vehicle which is mounted with the fuel cell stack according to claim 13 and uses the fuel cell stack as power source.

15. A method for manufacturing a separator for a fuel cell comprising:
preliminary press forming a clad thin plate obtained by forming a precious metal layer on a surface of a metal plate to perform rolling work on the metal plate at a draft of 5% to 15% to make clad to elongate the clad thin plate; and
finishing press forming the clad thin plate in a predetermined corrugated shape to form a gas flow path portion.

16. The method for manufacturing a separator for a fuel cell according to claim 15, wherein the finishing press forming step is for performing bending work on the clad thin plate to constitute a gas flow path groove with a corrugated shape, and applying a compression stress in a direction orthogonal to the gas flow path groove in a plane direction of the clad thin plate at a time of the bending work.

17. The method for manufacturing a separator for a fuel cell according to claim 15, wherein the preliminary press forming is for elongating the clad thin plate to conduct press forming such that a formation height of the clad thin plate after the preliminary press forming is at least 1.25 times a formation height of a product.
